(19) United States
(12) Patent Application Publication
(10) Pub. No.: US 2026/0211612 A1
(43) Pub. Date: Jul. 23, 2026

(54) Audio Device with Machine Learning (ML) Based Content Detection

(71) Applicant: Bose Corporation, Framingham, MA (US)

(72) Inventors: Xiao Quan, West New York, NJ (US); Miriam Israelowitz, Natick, MA (US); Shuo Zhang, Cambridge, MA (US); Nitin Ravindra Hugar, Worcester, MA (US); Christopher J. Perkins, Southborough, MA (US)

(21) Appl. No.: 19/027,307

(22) Filed: Jan. 17, 2025

(51) Int. Cl. G06F 3/16

(52) U.S. Cl. CPC G06F 3/165

(57) ABSTRACT

Various implementations include audio devices and methods for content detection in audio signals. Certain implementations include an audio device, including: at least one processor configured to: receive an audio input signal; extract content-based features from the audio input signal; provide the extracted content-based features to a machine learning (ML) based content detection module running at the audio device; and adjust an audio output setting for the output based on a content indicator from the ML based content detection module.

### TECHNICAL FIELD

This disclosure generally relates to audio devices. More particularly, the disclosure relates to content-based audio control in electronic devices such as audio devices.

### BACKGROUND

Certain types of audio content can benefit from specific output settings, for example, tuning, spatialization, etc.. However, it may not be desirable to output all types of content similarly. Conventional approaches to output control can limit the user experience.

### SUMMARY

All examples and features mentioned below can be combined in any technically possible way.

Various implementations include approaches for controlling audio output settings based on content indictors. Particular implementations use a machine learning (ML) based content detection module to determine a content indicator for audio input signals.

In some particular aspects, an audio device includes: at least one processor configured to: receive an audio input signal; extract content-based features from the audio input signal; provide the extracted content-based features to a machine learning (ML) based content detection module running at the audio device; and adjust an audio output setting for the output based on a content indicator from the ML based content detection module.

In additional particular aspects, a method of controlling an audio device includes: receiving an audio input signal; extracting content-based features from the audio input signal; providing the extracted content-based features to a machine learning (ML) based content detection module running at the audio device; and adjusting an audio output setting for the output based on a content indicator from the ML based content detection module.

Implementations may include one of the following features, or any combination thereof.

In some cases, content-based features include one or more of: a) log mel power spectrogram, b) mean squared energy (e.g., energy of the spectrum, which may be used as a substitute for RMS or root-mean-squared), and c) zero crossing rate (e.g., a number of sign changes in consecutive blocks of audio, such that a high crossing rate indicates noisy/high frequency content, and low crossing rate indicates a more periodic signal).

In certain aspects, audio output settings that can be adjusted include one or more of: i) play/pause/skip control, ii) volume control, iii) tuning selection (e.g., including equalization), iv) audio spatialization, etc.

In certain cases, the ML based content detection module is configured to provide the content indicator independently of metadata about the audio input signal.

In some cases, the processor does not have access to the metadata about the audio input signal.

In some cases, the metadata about the audio input signal is used to verify the content indicator.

In some cases, the content indicator categorizes the audio input signal in one of the following categories: music, spoken word, audio for video, gaming audio, or miscellaneous audio. In some examples, spoken word content can include podcasts, talk radio, etc. In particular examples, content categories are identified based on characteristics, for example, music can be identified based on harmonics, tonal elements, periodic onsets, spoken word can identified based on silences, concentrated spectral energy, formants, and audio for video can be identified based on spread-out spectral energy, and tonal + harmonic elements + noise. In additional examples, the signal can be broadly classified as one or more of: speech dominant, music dominant, or a mix. Mixed signals can be evaluated at a secondary level (process) in some cases.

In some cases, the content-based features are extracted in a frame-wise approach. For example, the frame-wise approach can include frame sizes of approximately 512 with hop sizes of 256, or equivalent ratios. Aggregate features can also be evaluated over a period (e.g., a period of seconds such as ten seconds) for characteristics such as mean, variance, etc. Running means and/or variances can be used to reduce MIPS usage.

In some cases, the ML based content detection module is trained using normalized training data. In some cases, the training data can be normalized by frame size to remove (or at least mitigate) the effect of volume. Training data can also be subject to category balancing to control how much of each category type is included in the training set. In various implementations, training data can include audio data from each of a set of content types.

In some cases, the normalized training data is fed back into the ML based content detection module iteratively during the training.

In some cases, the processor is further configured to down-sample the audio input signal prior to extracting the content-based features.

In some cases, the processor is further configured to apply a hysteresis factor prior to adjusting the audio output setting for the audio output to mitigate undesirable switching.

In some cases, the ML based content detection module is a computationally limited version of a counterpart ML based content detection module trained remotely from the audio device. In some examples, the training is performed on another device that is separate from the audio device, e.g., by simulating limits of the audio device. In certain examples, a device simulator is used to define fixed point value limits of the device (e.g., audio device) on which the ML based content detection module is configured to run. The training can be run with the limits of the target (audio) device.

In some cases, the at least one processor is a fixed point device processor.

In other cases, the at least one processor includes a floating point processor.

In some cases, the ML based content detection module is sized based on computational parameters of the processor. In some cases, the ML based content detection module is device-specific based on distinct processing capabilities, e.g., coded to the fixed point processor and verified against floating point generalized code. Training code can be modified to take into account limits of the fixed point processor.

In some cases, the audio device further includes at least one electro-acoustic transducer and a microphone each coupled with the at least one processor, where the audio input signal is configured for output by the at least one electro-acoustic transducer.

In some cases, a wearable audio device includes the audio device.

In some cases, a soundbar includes the audio device.

In some cases, a vehicle audio system includes the audio device.

Two or more features described in this disclosure, including those described in this summary section, may be combined to form implementations not specifically described herein.

The details of one or more implementations are set forth in the accompanying drawings and the description below. Other features, objects and advantages will be apparent from the description and drawings, and from the claims.

### BRIEF DESCRIPTION OF THE DRAWINGS

FIG. 1 is a block diagram of a system including a set of devices according to various disclosed implementations.

FIG. 2 is flow diagram illustrating processes in a method according to various implementations.

FIG. 3 is a signal flow diagram illustrating approaches for content-based audio output control according to various implementations.

FIG. 4 is a data flow diagram illustrating aspects of content classification according to various implementations.

It is noted that the drawings of the various implementations are not necessarily to scale. The drawings are intended to depict only typical aspects of the disclosure, and therefore should not be considered as limiting the scope of the implementations. In the drawings, like numbering represents like elements between the drawings.

### DETAILED DESCRIPTION

This disclosure is based, at least in part, on the realization that controlling audio output based on content can enhance the user experience.

Certain conventional audio systems employ audio output setting adjustments without consideration for content type. Because different types of content can benefit from audio output settings (e.g., tuning, playback controls, volume selection, spatialization, orchestration, etc.) in distinct ways, these conventional systems have deficiencies. Further, some conventional audio systems that are capable of considering content type in controlling audio output determine content type with content metadata (e.g., metadata that accompanies an audio input signal). This metadata can provide key indicators of content type.

However, not all audio devices have access to this content metadata. For example, certain audio input signals are coded to comply with particular device manufacturers, and/or are specifically provided without associated metadata, e.g., to restrict access to one or more portions of the metadata. In contrast to conventional approaches, the devices, systems and methods disclosed according to various implementations extract content-based features from audio input signals and use a machine-learning (ML) based module to determine a content indicator of those input signals. The content indicator is used to adjust an audio output setting. In particular cases, the ML based module is located at the audio device, and in some examples, is configured to determine a content indicator independently of audio input signal metadata. In these cases, the audio device can be configured to control audio output based on content type without requiring input signal metadata.

Commonly labeled components in the FIGURES are considered to be substantially equivalent components for the purposes of illustration, and redundant discussion of those components is omitted for clarity.

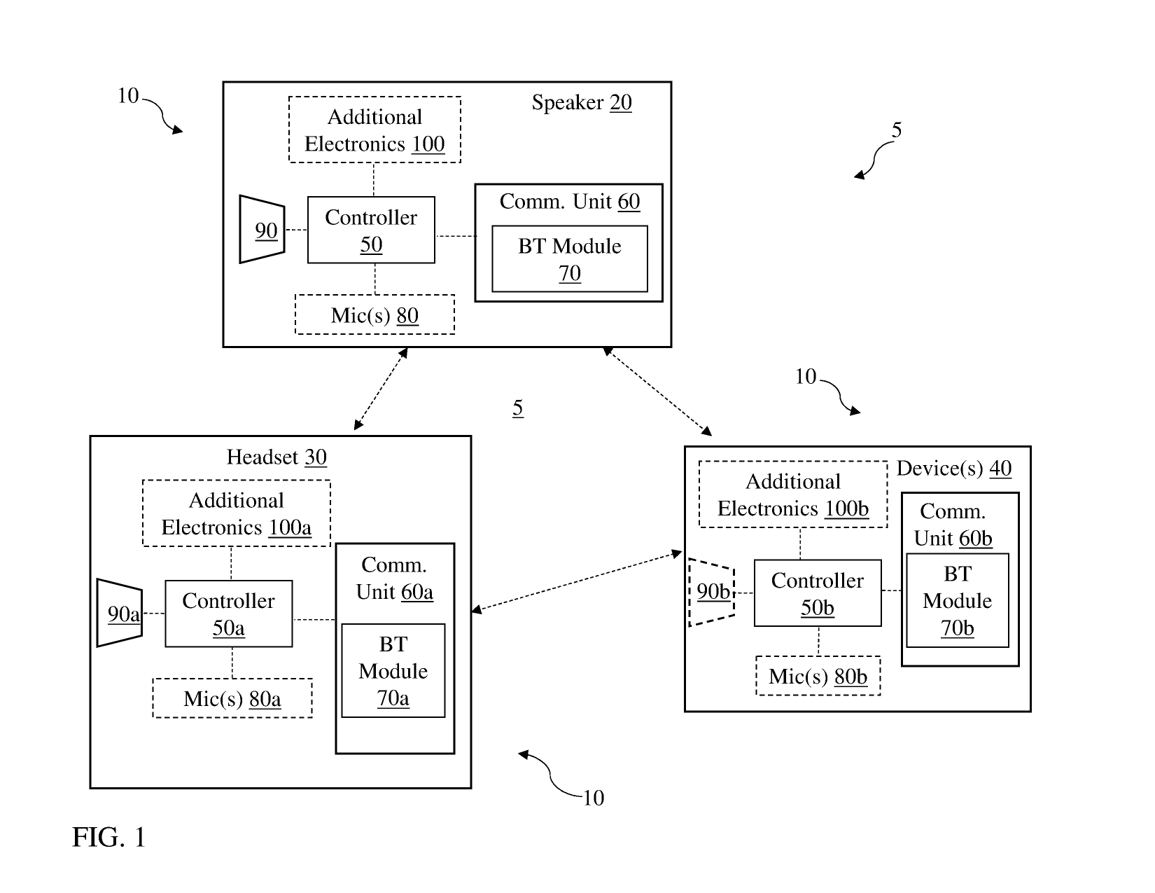

FIG. 1 shows an example of a system 5 including a set of devices 10 including according to various implementations. In various implementations, the devices 10 include audio devices such as a speaker 20, and/or an audio headset 30. In some cases, the speaker 20 includes a soundbar, portable speaker, a home speaker, an automobile speaker, etc. In certain implementations, the headset 30 is part of a wearable audio device such as in-ear, on-ear, or near-ear audio devices, e.g., earbuds, earphones, wearable audio glasses, body-worn speakers, etc. One or more additional device(s) 40 are shown, which are optional in some implementations. Additional device(s) 40 can include audio devices such as smart phones, tablets, computing devices, television or audio/visual display devices, etc., that have at least one speaker. In other cases, device(s) 40 include devices not configured to output audio, for example, docking devices, charging devices, audio gateway devices, amplifiers, display-only devices, etc. The additional device(s) 40 can be configured to communicate with the speaker 20 and/or headset 30 and/or other electronic devices using any communications protocol or approach described herein. Non-limiting examples of audio devices that can benefit from the various disclosed implementations include: Bose QuietComfort Headphone and Earbud varieties, Bose Frames, Bose Smart Soundbar varieties, the Bose TV Speaker, Bose Surround Speaker varieties, the Bose Bass Module, the Bose Soundlink varieties and/or the Bose Portable Smart Speaker, all by Bose Corporation of Framingham, MA, USA.

In certain cases, the devices 10 include a controller 50 and a communication (comm.) unit 60 coupled with the controller 50. In certain examples, the communication unit 60 includes a Bluetooth module 70 (e.g., including a Bluetooth radio), enabling communication with other devices over Bluetooth protocol. In certain example implementations, devices 10 can also include one or more microphones (mic(s)) 80 (e.g., a single microphone or a microphone array), and at least one electro-acoustic transducer 90 for providing an audio output. The devices 10 can also include additional electronics 100, such as a power manager and/or power source (e.g., battery or power connector), memory, sensors (e.g., IMUs, accelerometers/gyroscope/magnetometers, optical sensors, voice activity detection systems), etc. In some cases, the memory may include a flash memory and/or non-volatile random access memory (NVRAM). In particular cases, memory stores: a microcode of a program for processing and controlling the controller 50 and a variety of reference data; data generated during execution of any of the variety of programs performed by the controller 50; a Bluetooth connection process; and/or various updateable data for safekeeping such as paired device data, connection data, device contact information, etc. Certain of the above-noted components depicted in FIG. 1 are optional, and are displayed in phantom.

In certain cases, the controller 50 can include one or more microcontrollers or processors having a digital signal processor (DSP). In some cases, the controller 50 is referred to as control circuit(s) and/or processor(s). The controller(s) 50 may be implemented as a chipset of chips that include separate and multiple analog and digital processors. The controller 50 may provide, for example, for coordination of other components of the devices 10, such as control of user interfaces (not shown) and applications run by the devices 10. In various implementations, controller 50 includes a content-based audio control module, which can include software and/or hardware for performing audio control processes described herein. For example, controller 50 can include a content-based audio control module in the form of a software stack having instructions for controlling functions in outputting audio to one or more devices 10 according to any implementation described herein. As described herein, the controller 50, as well as other controller(s) described herein, is configured to control functions in audio output control according to various implementations. In particular cases, as noted herein, the controller 50 can include a machine learning (ML) based content detection module that is configured to detect content in an audio input signal for use in controlling audio output at the device(s).

The communication unit 60 can include the BT module 70 configured to employ a wireless communication protocol such as Bluetooth, along with additional network interface(s) such as those employing one or more additional wireless communication protocols such as IEEE 802.11, Bluetooth Low Energy, or other local area network (LAN) or personal area network (PAN) protocols such as WiFi. In particular implementations, communication unit 60 is particularly suited to communicate with other communication units 60 in devices 10 via Bluetooth, BLE, broadcast, synchronized unicast, and/or a synchronized downmixed audio connection over BT or other wireless connection (also referred to as SimpleSync^{TM}, a proprietary connection protocol from Bose Corporation, Framingham, MA, USA). In still further implementations, devices 10 can communicate with one another via a hard-wired connection, e.g., between any two or more devices. Additional description of various devices, connection approaches, and/or content-based control functions are described in US Patent Application No. 18/238,668 (“Content-Based Audio Spatialization,” filed August 28, 2023), the entire contents of which are incorporated by reference herein.

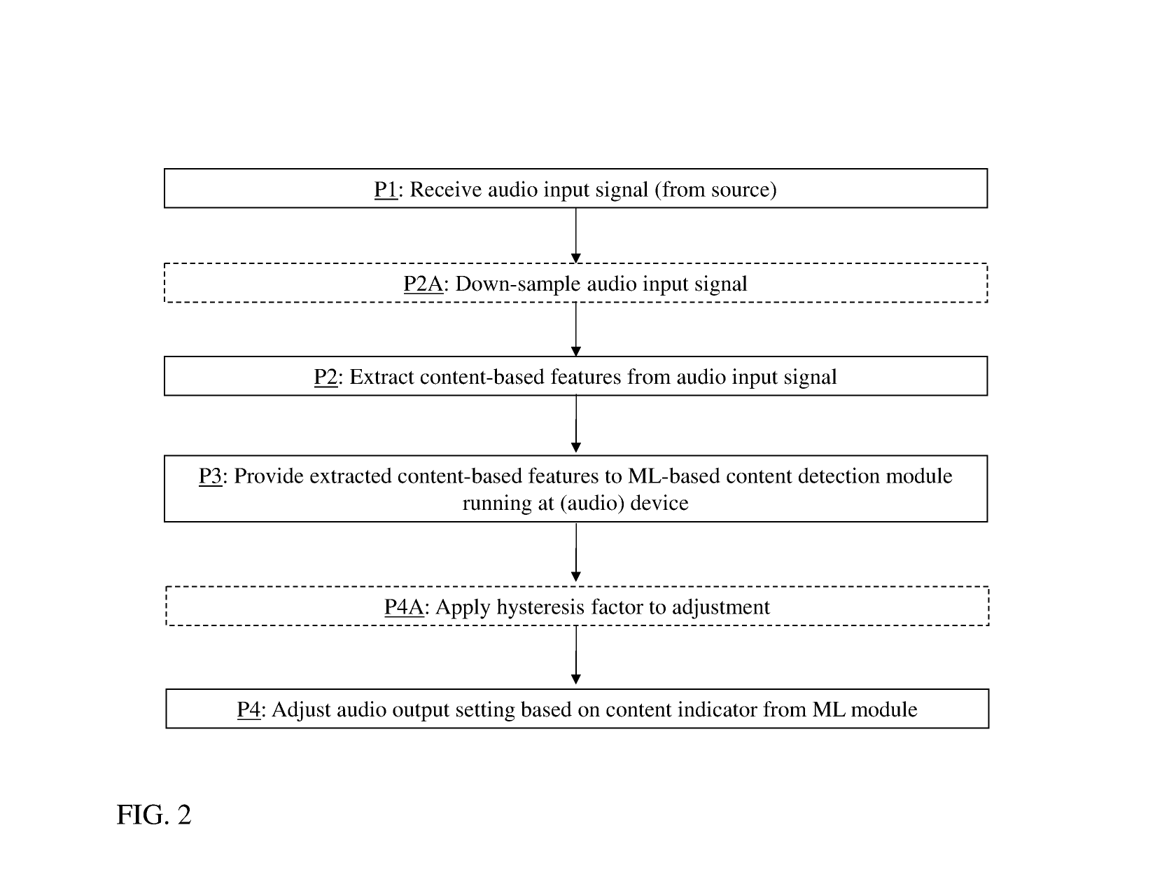

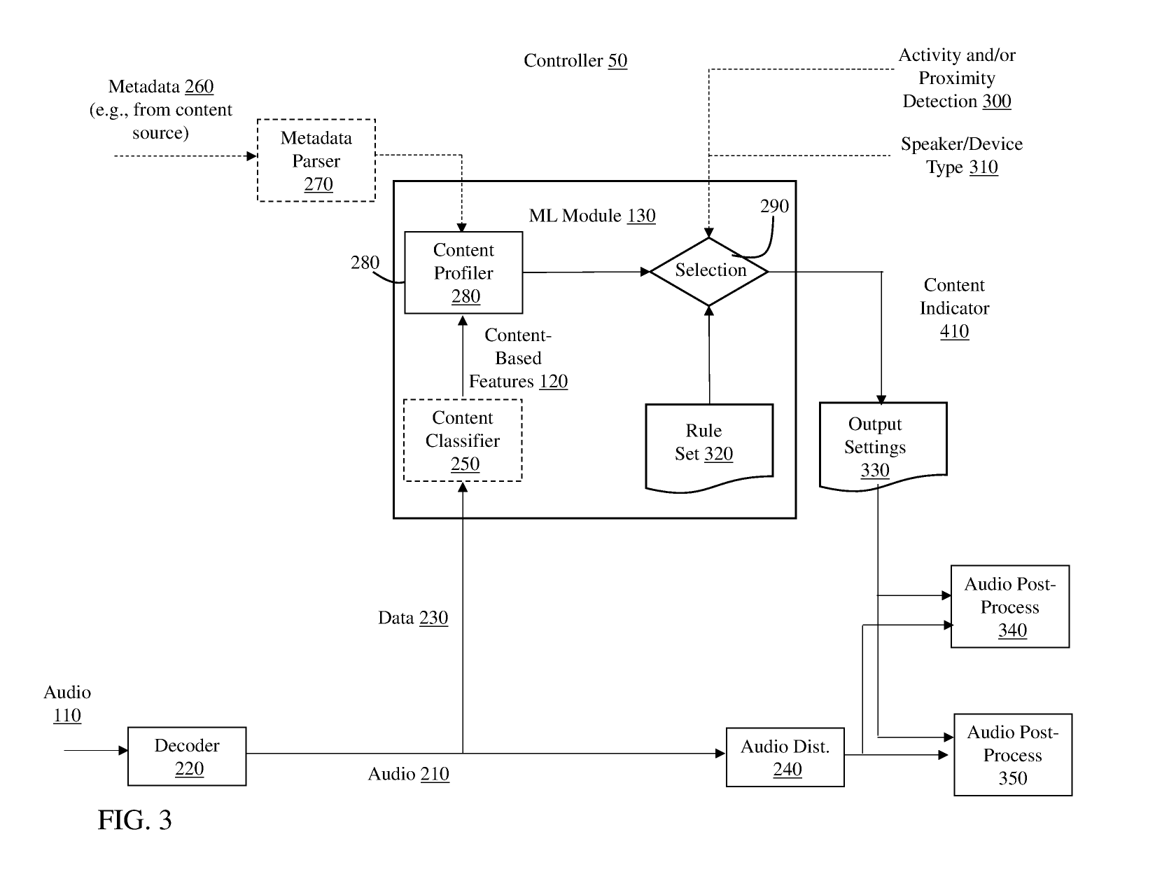

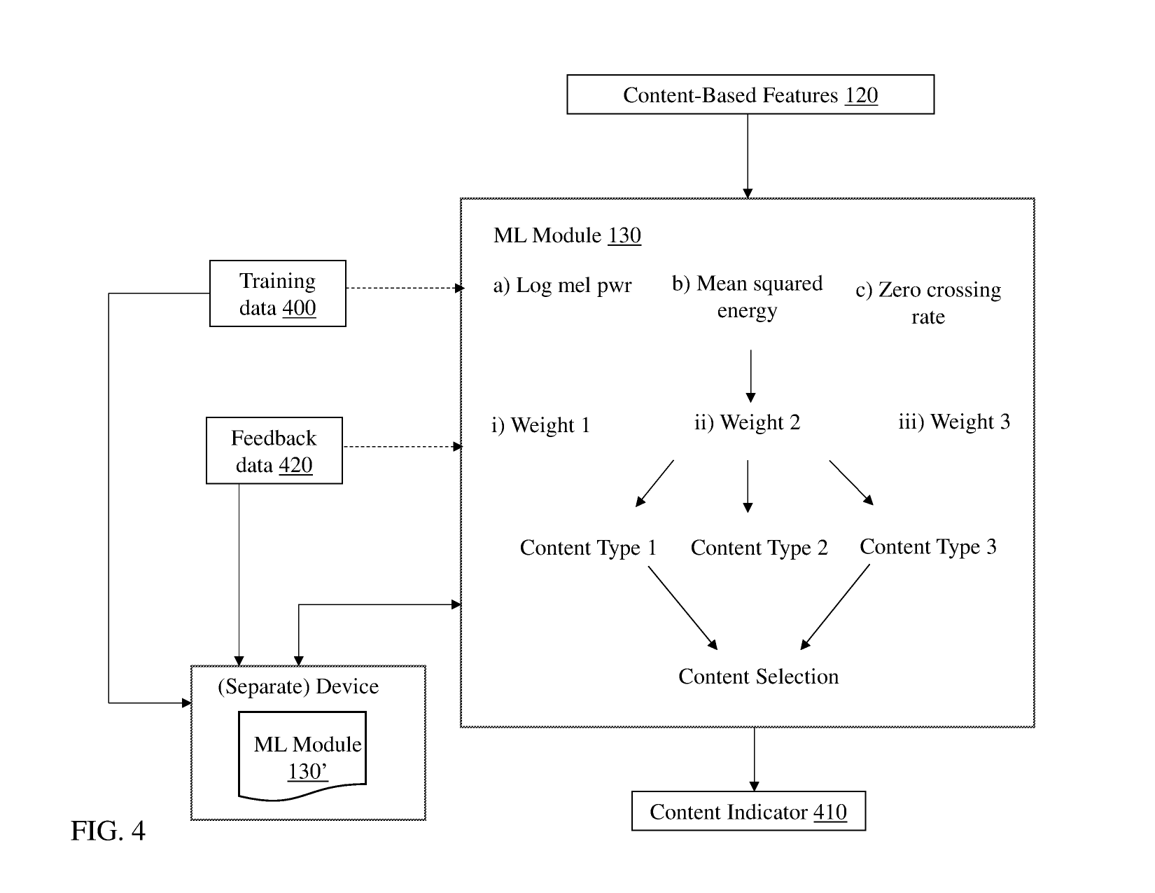

FIG. 2 is a flow diagram illustrating processes performed by controller 50 (e.g., one or more processors) in performing content-based audio control according to various implementations. FIG. 3 is a data flow diagram illustrating aspects of the controller 50 in a device 10 according to various implementations. FIG. 4 shows data flows in a content identifier such as a machine-learning (ML) based module according to various implementations. The ML-based module can be configured (e.g., via program product instructions executed at one or more processors and/or microprocessors) to perform processes in controlling audio output based on a content indicator. Turning to FIGS. 2 and 3, the controller 50 can be configured to perform processes including:

P1: receive an audio input signal 110, e.g., from an audio source. In particular cases, the audio input signal 110 includes an audio file or stream obtained from an audio source (e.g., a stored or transmitted audio file and/or a cloud-based audio streaming platform). In some cases, the audio input signal 110 can include data about at least one of, a number of channels in the audio output, encoding information about the audio output, or a type of the audio (e.g., DOLBY Atmos with a 5.1 baseline track and object data such as x-y-z coordinate data) for output from the signal 110.

In some example implementations, as shown in FIG. 3, audio (e.g., a file or stream) 110 is obtained from an audio source (e.g., a stored or transmitted audio file and/or a cloud-based audio streaming platform) and an audio decoder 220 separates data 230 about the audio output for use in determining at least one audio output setting at the speaker(s). In one example, audio 110 is forwarded to an audio distributor 240 for post-processing and distributing to one or more speakers such as speaker 20 and/or headset 30 (FIG. 1).

P2: extract content-based features 120 from the audio input signal 110. In certain cases, the data 230 from audio input 110 is sent to a content classifier 250 for extracting the content-based features 120 from the audio 210. In particular examples, the content classifier 250 is configured to determine the type of content in the audio 210 based on the presence of one or more content-based features 120. In additional implementations, features of the content classifier 250 are integrated into the ML module 130, e.g., as illustrated in phantom in FIG. 3. In particular cases, the content classifier 250 can detect whether the audio content contains characteristics indicative of a content type, e.g., music, spoken word, audio for video (A4V), gaming audio, or miscellaneous audio. Such content types may be detectable based on content-based features 120, e.g., whether the audio 110 includes dialog, music, crowd noise, etc. In some cases, content-based features 120 include one or more of: a) log mel power spectrogram, b) mean squared energy (e.g., energy of the spectrum, which may be used as a substitute for RMS or root-mean-squared), and c) zero crossing rate (e.g., a number of sign changes in consecutive blocks of audio, such that a high crossing rate indicates noisy/high frequency content, and low crossing rate indicates a more periodic signal). In particular implementations, the content-based features are extracted in a frame-wise approach. For example, the frame-wise approach can include frame sizes of approximately 512 with hop sizes of 256, or equivalent ratios. Aggregate features can also be evaluated over a period (e.g., a period of seconds such as ten seconds) for characteristics such as mean, variance, etc. According to some non-limiting examples, running means and/or running variances are used, e.g., to reduce MIPS usage.

In some optional implementations, as illustrated in FIG. 2, the controller 50 can be configured to down-sample the audio input signal 110 prior to extracting the content-based features 120 (process P2A).

With continuing reference to FIG. 2, after extracting the content-based features 120 from the input signal 110, the controller 50 is further configured to:

P3: provide the extracted content-based features 120 to a machine learning (ML) based content detection module (ML module) 130 running at the (audio) device 10. As noted herein, in some cases, the ML module 130 is a computationally limited version of a counterpart ML based content detection module 130’ (FIG. 4) trained remotely from the audio device 10. In some examples, the training is performed on another device that is separate from the audio device, e.g., by simulating limits of the audio device 10. For example, the device 10 running the computationally limited ML module 130 can include an audio device such as audio device 20 or audio device 30, and the counterpart ML based content detection module 130’ can be run on a computing device such as device 40 or a cloud-based platform that is configured to be coupled to audio device 20 and/or audio device 30. In certain examples, a device simulator is used to define fixed point value limits of the device (e.g., audio device) 10 on which the ML module 130 is configured to run. In particular cases, training the ML module 130 is run with the limits of the target (audio) device 10. In some cases, the controller (e.g., at least one processor) 50 is a fixed point device processor, and the ML module 130 is trained with the constraints of a fixed point device processor. In certain cases, the ML module 130 is sized based on computational parameters of the controller 50 at the device 10 (e.g., audio speaker 20 or headset 30). For example, in some cases, the ML module 130 is device-specific based on distinct processing capabilities, e.g., coded to the fixed point processor and verified against floating point generalized code. Training code can be modified to take into account limits of the fixed point processor.

It is noted that while in some implementations the controller (including one or more processors) 50 includes a fixed point processor, in additional implementations, the controller 50 can include a floating point processor, e.g., with greater computational capabilities than a fixed point processor.

In some cases, the ML module 130 includes a model trained using normalized training data 400 (FIG. 4). In some cases, the training data 400 can be normalized by frame size to remove (or at least mitigate) the effect of volume. Training data 400 can also be subject to category balancing to control how much of each category type is included in the training set. In various implementations, training data 400 can include audio data from each of a set of content types. In some cases, the normalized training data 400 is fed back into the ML module 130 iteratively during the training. As illustrated in the data flow diagram in FIG. 4, the training data 400 can be used to train the ML module 130 at the device 10, and/or the ML module 130’ at the separate device.

In some cases, as described herein, the ML module 130 is configured to provide a content indicator 410 as an output, e.g., for use in controlling audio output at the (audio) device 10.

In particular cases, the ML module 130 provides the content indicator 410 independently of metadata 260 about the audio input signal 110 (FIG. 3). For example, in some cases, the controller 50 does not have access to the metadata 260 about the audio input signal 110. In some additional cases, the controller 50 has access to the metadata 260 about the audio input signal 110, and only uses that metadata 260 to verify the content indicator 410. With continuing reference to FIG. 3, in some examples, the ML module 130 includes a selector 290 that applies one or more rule sets 320 for providing a content indicator.

In particular examples, the content indicator 410 categorizes the audio input signal 110 in one of the following categories: music, spoken word, audio for video (A4V), gaming audio, or miscellaneous audio. In some examples, spoken word content can include podcasts, talk radio, etc. In particular examples, content categories are identified based on characteristics, for example: a) music can be identified based on harmonics, tonal elements, periodic onsets, b) spoken word can identified based on silences, concentrated spectral energy, formants, and c) audio for video can be identified based on spread-out spectral energy, and tonal + harmonic elements + noise. In additional examples, the signal 110 can be broadly classified as one or more of: speech dominant, music dominant, or a mix. Mixed signals can be evaluated at a secondary level (process) in some cases. For example: secondary evaluation can be based on predicted dominance and/or predicted least-harm. In a particular example, mixed signals (e.g., signals that are not A4V) can be evaluated by buffering predictions in time and deciding which prediction dominates, or which prediction causes the least amount of harm.

FIG. 4 illustrates a non-limiting example of data flows in ML module 130, which can include a ML content classifier as described herein. In these cases, the ML module 130 can be trained using training data 400 that includes audio data and/or metadata about audio to develop distinctions in audio characteristics, content types, and/or audio file information. It is understood that the ML module 130 can be updated over time with additional training data 400, as well as feedback data 420 such as user feedback about content type selections for audio output (as described herein). Further, new data 230 (FIG. 3) can be used to update the ML module 130 in making future selections of content indicator 410. In various implementations, the ML module 130 is configured to analyze the data (e.g., audio data) that includes content-based features 120 for indicators of content types (e.g., Content Type 1, Content Type 2, etc.). As noted herein, content-based features 120 can include one or more of: a) log mel power spectrogram, b) mean squared energy (e.g., energy of the spectrum, which may be used as a substitute for RMS or root-mean-squared), and c) zero crossing rate (e.g., a number of sign changes in consecutive blocks of audio, such that a high crossing rate indicates noisy/high frequency content, and low crossing rate indicates a more periodic signal). The preceding list of content-based features is merely illustrative, as various additional content-based features 120 can be analyzed for indicators of content types. In particular optional implementations, additional features can be evaluated such as: dynamic range; sub-content in the (audio) data 230 such as dialog, music, crowd noise; and/or data file/stream characteristics such as encoding, number of channels, or audio file type. In particular examples, weights (e.g., Weight 1, Weight 2, Weight 3, etc.) are applied to one or more features 120, e.g., based on the presence of such features in a given time frame, relative presence of a feature 120 in a given time frame, and/or the absolute or relative presence of a feature 120 in a rolling average. Further, combinations of features 120 can increase the likelihood of a particular type of content, and as such, distinct weights can be applied to one or more features 120 based on the presence of two or more features 120 in a given time frame. In some examples, feature weights are determined by training the ML module 130. For example, weight values for a given feature 120 can be assigned according to frequencies, sub-frequencies, and/or frequency bands. In a particular example, training output from the ML module 130 assigns greater weight value for log mel spectrogram variance across all frequencies for a content type (e.g., Content Type 1, such as music), as compared with assigning greater weight value for log mel spectrogram variance at specific frequencies or narrower ranges for a distinct content type (e.g., Content Type 2, such as A4V). Based on these characteristics of the data 230 (e.g., features 120), the ML module 130 selects one or more likely content types, e.g., Content Type 1, Content Type 2, Content Type 3, etc.

Returning to FIGS. 3 and 4, the output of the content classifier 250 (if separate from ML module 130) is provided to a content profiler 280 and a content selection 290 is made, e.g., based on the content type. In particular cases, the controller 50 makes the selection automatically based on the determined content type, that is, without a user input. In some examples, the content profiler 280 combines content-based features 120 input from content classifier 250 with the output of a metadata parser 270 (if metadata 260 is available), e.g., to aid in determining the content indicator 410.

With continuing reference to FIGS. 2 and 3, after the content indicator 410 is provided by the ML module 130, the controller 50 is further configured to adjust an audio output setting 330 for the output based on that content indicator 410 (P4). In certain aspects, audio output settings 330 that can be adjusted include one or more of: i) play/pause/skip control, ii) volume control, iii) tuning selection (e.g., including equalization), iv) audio spatialization, v) mode selection (e.g., including hear-through mode otherwise known as “aware” mode, noise cancelation mode, pairing mode, etc.), etc. In some cases, the selected content indicator 410 can be applied, e.g., with output settings 330 (e.g., applying one or more digital signal processing profiles) to audio output signals from audio distributor 240, e.g., for post-processing output at headphone(s) 30 (post-processing signals 340) and/or speaker(s) 20 (post-processing signals 350).

In some cases, as shown optionally as process (P4A) in FIG. 2, the controller 50 is further configured to apply a hysteresis factor prior to adjusting the audio output setting 330 for the audio output, e.g., to mitigate undesirable switching. In some cases, the hysteresis factor includes a delay of approximately ten seconds or less, approximately several seconds or less, or approximately one to two seconds or less.

According to certain implementations, the content classifier 250 and/or ML module 130 can be updated over time, e.g., with more classifier to audio data comparisons and/or adjustments based on user feedback. For example, the content classifier 250 and/or ML module 130 can be updated as additional data 230 is received and corresponding spatialization modes are applied to audio output. In some cases, the controller 50 is configured to update the content classifier 250 and/or ML module 130 based on user feedback such as a user adjustment of audio settings after audio is output in a particular spatialization mode. In additional cases, the controller 50 is configured to update the content classifier 250 and/or ML module 130 after receiving user feedback (e.g., feedback data 420, FIG. 4), e.g., in response to a prompt such as an audio prompt, visual prompt, or tactile prompt at one or more devices such as a wearable audio device. In further cases, the controller 50 monitors audio adjustments made by the user (e.g., via interface(s) at the audio device) in a period following initiation of spatialized audio output, e.g., within a few minutes after initiating spatialized audio output. In a particular example, the content classifier 250 is a machine learning (ML) content classifier, trained on data such as audio data (and audio metadata) and audio setting data and configured to determine a content type for the audio output from a group of content types. In some cases, the content classifier 250 is part of the ML module 130, and is trained and/or updated according to processes described herein relative to the ML module 130.

In still further implementations, the controller 50 is further configured to adjust the selected audio settings as additional data is received, e.g., additional data 230 from audio input signal 110 such as the progression of a stream of audio 110. Additional data can also include data from one or more sensors in additional electronics 100, and/or data from communication unit 60.

While various example configurations of devices and sources are described herein, it is understood that any device in an environment can act as a source device, a sink device, and/or a connected device in a grouping of audio devices. For example, the speaker 20 and the headset 30 can be connected with a common source device such as one of the additional devices (e.g., television, audio gateway device, smartphone, tablet computing device, etc.) 40 described herein. For example, the source device can include a television system, a smartphone or a tablet. In additional implementations, the source device includes a network-based and/or cloud-based device such as a network connected audio system. In further implementations, the speaker 20 and/or the headset 30 act as a source device, for example, with integrated network and/or cloud communications capabilities. In such a case, the speaker 20 and/or headset 30 receive audio signals from a network (or cloud) connected gateway device such as a wireless or hard-wired internet router.

In any case, the approaches described according to various implementations have the technical effect of enhancing audio output for a user based on the detected type of audio content. For example, the approaches described according to various implementations control audio output at one or more devices based on an identified type of the audio content output at those speakers. In certain cases, the approaches can effectively identify types of audio content without content metadata, enhancing the adaptability of a system deploying such approaches. Users of the disclosed systems and methods experience an enhanced, immersive audio experience when compared with conventional systems.

The above description provides embodiments that are compatible with BLUETOOTH SPECIFICATION Version 5.2 [Vol 0], 31 Dec. 2019, as well as any previous version(s), e.g., version 4.x and 5.x devices. Additionally, the connection techniques described herein could be used for Bluetooth LE Audio, such as to help establish a unicast connection. Further, it should be understood that the approach is equally applicable to other wireless protocols (e.g., non-Bluetooth, future versions of Bluetooth, and so forth) in which communication channels are selectively established between pairs of stations.

In some implementations, the host-based elements of the approach are implemented in a software module (e.g., an “App”) that is downloaded and installed on the source/host (e.g., a “smartphone,” television, soundbar, or smart speaker), in order to provide the spatialized audio output aspects according to the approaches described above.

While the above describes a particular order of operations performed by certain implementations of the invention, it should be understood that such order is illustrative, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

The functionality described herein, or portions thereof, and its various modifications (hereinafter “the functions”) can be implemented, at least in part, via a computer program product, e.g., a computer program tangibly embodied in an information carrier, such as one or more non-transitory machine-readable media, for execution by, or to control the operation of, one or more data processing apparatus, e.g., a programmable processor, a computer, multiple computers, and/or programmable logic components.

A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a network.

Actions associated with implementing all or part of the functions can be performed by one or more programmable processors executing one or more computer programs to perform the functions of the calibration process. All or part of the functions can be implemented as, special purpose logic circuitry, e.g., an FPGA and/or an ASIC (application-specific integrated circuit). Processors suitable for the execution of a computer program include, by way of example, both general and special purpose microprocessors, and any one or more processors of any kind of digital computer. Generally, a processor will receive instructions and data from a read-only memory or a random access memory or both. Components of a computer include a processor for executing instructions and one or more memory devices for storing instructions and data.

In various implementations, unless otherwise noted, electronic components described as being “coupled” can be linked via conventional hard-wired and/or wireless means such that these electronic components can communicate data with one another. Additionally, sub-components within a given component can be considered to be linked via conventional pathways, which may not necessarily be illustrated.

A number of implementations have been described. Nevertheless, it will be understood that additional modifications may be made without departing from the scope of the inventive concepts described herein, and, accordingly, other embodiments are within the scope of the following claims.

We claim:

1. An audio device, comprising:
at least one processor configured to:
receive an audio input signal;
extract content-based features from the audio input signal;
provide the extracted content-based features to a machine learning (ML) based content detection module running at the audio device; and
adjust an audio output setting for the output based on a content indicator from the ML based content detection module.

2. The audio device of claim 1, wherein the ML based content detection module is configured to provide the content indicator independently of metadata about the audio input signal.

3. The audio device of claim 2, wherein the processor does not have access to the metadata about the audio input signal.

4. The audio device of claim 2, wherein the metadata about the audio input signal is used to verify the content indicator.

5. The audio device of claim 1, wherein the content-based features are extracted in a frame-wise approach, and
wherein the content indicator categorizes the audio input signal in one of the following categories: music, spoken word, audio for video, gaming audio, or miscellaneous audio.

6. The audio device of claim 1, wherein the ML based content detection module is trained using normalized training data, wherein the normalized training data is fed back into the ML based content detection module iteratively during the training.

7. The audio device of claim 1, wherein the processor is further configured to perform at least one of:
a) down-sampling the audio input signal prior to extracting the content-based features, or
b) applying a hysteresis factor prior to adjusting the audio output setting for the audio output to mitigate undesirable switching.

8. The audio device of claim 1, wherein the ML based content detection module is a computationally limited version of a counterpart ML based content detection module trained remotely from the audio device.

9. The audio device of claim 1, wherein the at least one processor is a fixed point device processor.

10. The audio device of claim 1, wherein the ML based content detection module is sized based on computational parameters of the processor.

11. The audio device of claim 1, further comprising at least one electro-acoustic transducer and a microphone each coupled with the at least one processor, wherein the audio input signal is configured for output by the at least one electro-acoustic transducer.

12. A method of controlling an audio device, the method comprising:
receiving an audio input signal;
extracting content-based features from the audio input signal;
providing the extracted content-based features to a machine learning (ML) based content detection module running at the audio device; and
adjusting an audio output setting for the output based on a content indicator from the ML based content detection module.

13. The method of claim 12, wherein the ML based content detection module is configured to provide the content indicator independently of metadata about the audio input signal.

14. The method of claim 13, wherein the audio device does not have access to the metadata about the audio input signal.

15. The method of claim 13, wherein the metadata about the audio input signal is used to verify the content indicator.

16. The method of claim 12, wherein the content-based features are extracted in a frame-wise approach, and
wherein the content indicator categorizes the audio input signal in one of the following categories: music, spoken word, audio for video, gaming audio, or miscellaneous audio.

17. The method of claim 12, wherein the ML based content detection module is trained using normalized training data, wherein the normalized training data is fed back into the ML based content detection module iteratively during the training.

18. The method of claim 12, further comprising at least one of:
a) down-sampling the audio input signal prior to extracting the content-based features, or
b) applying a hysteresis factor prior to adjusting the audio output setting for the audio output to mitigate undesirable switching.

19. The method of claim 12, wherein the ML based content detection module is a computationally limited version of a counterpart ML based content detection module running remotely from the audio device.

20. The method of claim 12, further comprising sizing the ML based content detection module based on computational parameters of a processor at the audio device.
